(19) United States
(12) Patent Application Publication
(10) Pub. No.: US 2018/0174243 A1
(43) Pub. Date: Jun. 21, 2018

(54) SYSTEMS, METHODS AND APPARATUS FOR ENHANCED NAVIGATION IN PREPARATION OF AN ELECTRONIC TAX RETURN

(71) Applicant: INTUIT INC., Mountain View, CA (US)

(72) Inventor: Shekhar Mishra, Bengaluru (IN)

(21) Appl. No.: 15/385,078

(22) Filed: Dec. 20, 2016

(51) Int. Cl. G06Q 40/00; G06F 17/24; G06F 3/0482

(52) U.S. Cl. CPC G06Q 40/123; G06F 3/04847; G06F 3/0482; G06F 17/243

(57) ABSTRACT

Systems, methods and articles of manufacture for preparing an electronic tax return which prioritizes form fields and provides a user interface which displays each form field and indicates the status of each form field as a required form field, a completed form field or an optional form field, and also provides for easy and efficient navigation to each form field. The tax preparation system includes a software application having a rules module configured to analyze and prioritize a plurality of form fields based on a set of predetermined prioritization rules, a field mapper module configured to map form fields to respective status identifiers, and a user interface manager configured to generate a user interface for display to a user, the user interface including each of the form fields in an order based upon the priority ranking and a respective visible status marker associated with each of the form fields.

### BACKGROUND

Embodiments of the present invention are directed to systems, methods, and articles of manufacture for preparing an electronic tax return which provides a more efficient and enhanced user experience which reduces the amount of user interaction required to prepare an electronic tax return while also reducing the amount of computing and network communication resources required.

Computerized (also referred to as “electronic”) tax return systems have become very popular and allow a user, such as a taxpayer or a tax professional, to prepare and electronically file a tax return using a computing device (e.g. personal computer, tablet computer, smart phone, etc.). The tax preparation systems typically comprise a computer system having an electronic tax return software application. The tax preparation system may be a desktop computer having a tax preparation application that resides and operates on the computer operated by the user or an online system having a tax preparation application that resides on a server that is accessible by the user's computer via a network such as the internet. The interface for a server based system can be an internet browser or specialized software residing on the local computer. There are a number of examples of desktop software applications and online tax preparation applications for preparing tax returns. Examples of desktop applications are TurboTax® software for Microsoft Windows® based personal computers (“PC”) and Apple® Mac® computers, ProSeries® and Lacerte® tax preparation applications, which are known consumer and professional tax preparation applications available from Intuit Inc., Mountain View, Calif., H&R Block TaxCut software, available from H&R Block, Inc., Kansas City, Mo., and TaxACT® software available from 2nd Story Software, Inc. Examples of online tax return preparation applications are Turbotax® Online, H&R Block Online tax prep, and TaxACT® Online.

Whether a desktop system or an online system, the use of the application to prepare a computerized tax return is basically the same. For example, certain tax preparation applications present a list of tax-related questions or data entry fields to the user as a series of interview screens or fillable forms, in response to which the user enters the appropriate tax data and/or answers if they are known. For example, certain interview screens or questions may relate to personal and family information such as the user's social security number, marital status, number of dependents, etc. Other interview screens and questions may relate to the taxpayer's finances such as wages, retirement plan contributions, and social security, state and federal taxes that were paid or withheld as provided in Form-W2. The data fields of an electronic tax return may be entered in many other ways, as well. For example, data may be entered into the electronic tax return by filling in data fields in a fillable form, the data may be electronically imported from financial service providers of the taxpayer (such as banks, stock brokers, financial planners, etc.), the data may be transferred from another database on the computer or remotely stored on a different computer or storage device/server, and/or the data may be transferred from a previous year's tax return, or from any other suitable source.

Further, an electronic tax return may be a business or corporate return, and the tax data fields may, for example, relate to payments and benefits such as contributions to a retirement plan. Thus, data fields may relate to travel expenses or determinations of portions of expenses that are deductible.

Upon entry of all of the taxpayer data, the tax preparation system prepares an electronic tax return. The electronic tax return is then processed and formatted into an electronic tax return data file according to the requirements and specifications of the pertinent tax agency to which the tax return is being filed. Finally, the electronic tax return data file is filed with the appropriate tax authority such as the Internal Revenue Service (IRS), a state tax authority (e.g. California Franchise Tax Board), city tax authority, or other tax collecting agency, by transmitting the electronic tax return data file to the tax authority. Alternatively, the tax return data file can used to create a paper forms submission in which the tax return forms are printed and then submitted to the appropriate tax authority.

While these prior tax return preparation systems are useful, they are structured with a fixed, predetermined and/or pre-packaged structures or sequences of questions that are presented to all users as part of the forms filling or interview process. These prior tax return preparation systems use fixed forms having fixed orders of form fields to be completed, and/or fixed sequences of interview questions, that are static features and that are typically hard-coded elements of the tax return preparation system, and consequently, are not customizable or capable of being modified which, in turn, leads to “standardized” or inflexible electronic tax return user experiences, and user experience changes require re-programming and redeployment of the tax return preparation system itself. Consequently, while traditional tax return preparation applications may be comprehensive, they do not allow an easy and efficient way of informing a user of form fields and/or tax data needed to complete a tax return, or to navigate from one required form field to the next required form field, especially when navigating between required form fields on different form. This has a number of negative consequences including, for example, increased time and computing resources required to prepare an electronic tax return, user confusion, frustration and dissatisfaction with the tax return preparation application, and an impression that the tax return preparation application is impersonal or not applicable to the user, which may result in users abandoning the preparation process, switching to another tax return preparation application, or hiring a tax professional to prepare the electronic tax return, which is often much more expensive than using a tax return preparation application.

Accordingly, there is a need for improved computerized tax return preparation systems and methods which prioritizes required form fields which need to be filled-in to complete a tax return in order to reduce the amount of user interaction required to complete a tax return, and provides a user interface which clearly identifies required form fields and provides for fast and efficient navigation to and between required form fields.

### SUMMARY

One embodiment of the present invention is directed to a tax return preparation system (also referred to as a “tax preparation system”) configured to prepare a tax return for a taxpayer which prioritizes form fields to improve the efficiency with which a user can fill-in all required form fields to complete a tax return, and provides a user interface which conveniently and efficiently displays each form field and indicates the status of each form field as a required form field, a completed form field or an optional form field, and also provides for easy and efficient navigation to each form field, such as between form fields on the same tax form or between form fields on different tax forms. Typically, the tax preparation system comprises one or more computer(s) (such as a personal computer, tablet computer, mobile phone, smartphone, website server, etc.) in which the computer(s) include at least one computer processor, memory, a storage device and a tax preparation software program configured to program the computer to allow a user (e.g., a tax preparer) to prepare an electronic tax return for a taxpayer.

The tax preparation software program may be a desktop or local application (e.g., for operating on a personal computer), a mobile platform based application (e.g., for operating on a smartphone, or tablet computer), or browser based application which operates within a web browser on a computing device. The tax preparation software includes a rules module configured to analyze and prioritize a plurality of form fields based on a set of predetermined prioritization rules, a field mapper module configured to map form fields to respective status identifiers, a user interface manager configured to generate a user interface for display to a user, and a navigation module configured to transfer data between each of the field mapper, rules module, and a user interface manager. The tax preparation software application programs the computer to perform a process for preparing an electronic tax return for a taxpayer. First, the system receives tax form information from a web service. For instance, the web service may include tax form data regarding tax forms from various tax agencies such as the Internal Revenue Service (“IRS”) and state and local tax forms, a tax logic agent configured to analyze tax form data and current run-time tax data for a tax return to determine required form fields which are needed to complete one or more tax forms or a full tax return, and a tax calculation engine for calculating tax returns. The tax preparation system contemplates a centralized web service so that tax form data and tax calculations may be managed and updated centrally, rather than requiring updates at each client tax preparation system. The tax form information received by the system includes form fields for completing tax forms for a tax return being prepared for a taxpayer and other tax form data needed by the system to manage a user interface. The form fields includes “required fields” which have not been filled-in and are required to complete the tax return, completed fields which have been previously filled-in with tax data, and in some cases, optional fields which are fields which a user may fill-in with tax data but are not required in order to complete a tax form or a tax return. The rules module analyzes the tax form information and prioritizes the required fields to be filled out by the user using a pre-determined set of prioritization rules to generate a priority ranking of the form fields. The field mapper module generates a mapping which associates each of the form fields to respective status identifiers. This is typically done using the tax form information received from the web service. The status identifiers indicate whether a form field is a required field, a competed field, or in some cases, an optional field.

Then, the user interface manager receives the mapping and the priority ranking and utilizes the mapping and the priority ranking in order to generate a user interface for display to a user. The generated user interface includes each of the form fields in an order based upon the priority ranking and a respective visible status marker associated with each of the form fields. For example, the form fields may be listed in a column with a status marker for each form field in a column adjacent its respective form field. The status markers indicate whether the respective form field is a required field, a completed field, or in some cases, an optional field. The status markers may be any suitable marker in which the appearance for each status differs such that a user can quickly and easily identify the status of the associated form field. For example, the status markers may a colored bar or figure in which the color indicates the status, or a different shapes for each status, or a different word for each status, etc. The status markers are conveniently arranged in a diagnostic bar which the user can quickly and easily scan in order to find form fields of a particular status, such as one or more required fields.

In another feature, each of the status markers are selectable, such as selectable buttons or icons, which a user can select using a cursor or other user input device of the computer (e.g., a touchscreen, mouse, touchpad, etc.). When a status marker is selected, the system automatically places a cursor (including any type of an indicator used to show the current position for user interaction) in the form field associated with the selected status marker.

In still another feature, the pre-determined set of prioritization rules may include one or more of the following rules: (a) increasing a measure of priority of required fields which require the same tax data across different tax forms; (b) increasing a measure of priority of required fields which when completed will eliminate the need to fill-in other required fields; and/or (c) decreasing a measure of priority to required fields which are dependent upon other required fields. Each of these rules may be used to determine the priority of each form field relative to other form fields to determine the priority ranking in order to decrease the amount of user interaction required to complete the tax return.

In another aspect, the tax preparation system updates as a user enters tax data into the form fields of the user interface. When a user enters tax data into a form field, the user interface manager receives the tax data. The navigation module receives the tax data for the particular form field from the user interface manager and transmits the tax data to the web service. The web service then analyzes the current run-time data, including the new tax data, and determines updated required form fields which are needed to complete one or more tax forms or a full tax return. The tax preparation system receives updated tax form information from the web service, including updated form fields. The updated form fields include updated required fields, updated completed fields, and in some cases, updated optional fields. The tax preparation system then processes the updated tax information in the same manner described above to generate an updated user interface for display to the user. This process is repeated until all needed tax forms and the entire tax return are completed.

In still another feature, the tax preparation software application also includes a style editor module for customizing the look and feel of the user interface generated by the user interface manager. As some examples, the style editor may be configured to allow the user to customize the color, location, size, configuration, shape, and/or other characteristics of the diagnostic bar, the status markers, and/or the overall user interface.

In still another aspect, the navigation module may be configured to communicate with the web service via a Representational state transfer (RESTful) API (application program interface). A RESTful API is a software interface for providing interoperability between computer system over the internet.

In still another feature, the user interface generated by the user interface manager may also include form navigation commands to navigated between different tax forms. For instance, a user selectable “next form” command instructs the system to the next form after the current form being worked on by the user. A user selectable “previous form” command instructs the system to go back to the form before the current form being worked on by the user. The user selectable “next form” command and “previous form” command may be arrows or other selectable icons which indicate going forward to a next form and going backward to a previous form. The “next form” command and “previous form” command may also have respective status indicators, such as a particular color or other visible indicator to signify whether the “next form” has required fields. For example, the status indicators may be the same or similar to the respective status marker for the required field, the completed field, and the optional field, such as the same colors.

Another embodiment of the present invention is directed to computer-implemented methods for preparing an electronic tax return which prioritizes form fields to improve the efficiency with which a user can fill-in all required form fields to complete a tax return, and provides a user interface which conveniently and efficiently displays each form field and indicates the status of each form field as a required form field, a completed form field or an optional form field, and also provides for easy and efficient navigation to each form field, such as between form fields on the same tax form or between form fields on different tax forms. For example, the method may include a tax preparation system, same or similar to that described above, executing a tax preparation software program to prepare a tax return for a taxpayer. The method comprises the tax preparation system receiving tax form information from a web service, including form fields for completing tax forms for a tax return being prepared for a taxpayer, the form fields including required fields which have not been filled-in and are required to complete the tax return, completed fields which have been previously filled-in with tax data. The rules module analyzes the tax form information and prioritizes the required fields to be filled out by the user according to the pre-determined set of prioritization rules to generate a priority ranking of the form fields. The field mapper module generates a mapping associating each of the form fields to respective status identifiers, wherein the status identifiers indicate whether a form field is a required field, a competed field, or in some cases, an optional field. The user interface manager receives the mapping and the priority ranking and generates a user interface for display to a user using the mapping and the priority ranking. The user interface includes each of the form fields in an order based upon the priority ranking and a respective visible status marker associated with each of the form fields. The status markers are arranged in a diagnostic bar and indicate whether the respective form field is a required field, a completed field, or in some cases, an optional field.

In additional aspects of the present invention, the computer-implemented method may also include any of the additional aspects and features described herein for the tax preparation system.

Another embodiment of the present invention is directed to an article of manufacture comprising a non-transitory computer readable medium embodying instructions executable by a computer to execute a process according to any of the method embodiments of the present invention for preparing an electronic tax return. For instance, the non-transitory computer readable medium embodying instructions executable by a computer may be configured to execute a process comprising: a tax preparation system, same or similar to that described above, executing a tax preparation software program to prepare an electronic tax return. The process comprises: the tax preparation system receiving tax form information from a web service, including form fields for completing tax forms for a tax return being prepared for a taxpayer, the form fields including required fields which have not been filled-in and are required to complete the tax return, completed fields which have been previously filled-in with tax data, the rules module analyzing the tax form information and prioritizing the required fields to be filled out by the user according to the pre-determined set of prioritization rules to generate a priority ranking of the form fields; the field mapper module generating a mapping associating each of the form fields to respective status identifiers, the status identifiers indicating whether a form field is a required field or a competed field; and the user interface manager receiving the mapping and the priority ranking and generating a user interface for display to a user using the mapping and the priority ranking, the user interface including each of the form fields in an order based upon the priority ranking and a respective visible status marker associated with each of the form fields, the status marker indicating whether the respective form field is a required field or a completed field, the status markers arranged in a diagnostic bar.

In additional aspects, the article of manufacture may be further configured according to the additional aspects described herein for the tax preparation system and/or method for preparing an electronic tax return.

It is understood that the steps of the methods and processes of the present invention are not required to be performed in the order as shown in the figures or as described, but can be performed in any order that accomplishes the intended purpose of the methods and processes.

Accordingly, the tax preparation systems and methods of the present invention provide improved user interfaces, user experience and user interactions with computer generated interfaces and computerized tax return preparation applications for more efficient and accurate tax return preparation. The present invention utilizes improved data structures having prioritized form fields which provide for more efficient use of computing resources, including more efficient use of the processor, memory and network communications. The systems and methods of the present invention also provide more efficient use of the network communications of the internet as the less communication between the client system and the web services is required due to the optimization of the user interfaces and process for entering tax data. As a result, the present invention improves the functioning of the computer by providing faster and more flexible preparation, computing and generation of tax forms. Thus, the present invention improves various technologies and/or technical fields, including computerized preparation of tax returns, network computing, and user interfaces. forms. Accordingly, the present invention is rooted in computer technology involving specific computer components, intercommunications between computing modules, data structures and logic structures which improve the operation of the computer and also improve the technologies and technical fields recited above.

### BRIEF DESCRIPTION OF THE DRAWINGS

The foregoing and other aspects of embodiments are described in further detail with reference to the accompanying drawings, wherein like reference numerals refer to like elements and the description for like elements shall be applicable for all described embodiments wherever relevant:

FIG. 1 illustrates an exemplary tax preparation system for preparing an electronic tax return, according to one embodiment of the present invention;

FIG. 2 is a block diagram of a computing device (computer) which may be utilized in the system of FIG. 1;

FIG. 3 is a flow chart of a process performed by the tax preparation system of FIG. 1 to prepare an electronic tax return, according to one embodiment of the present invention;

FIG. 4 is a screen shot of an example of a user interface generated by the tax preparation system of FIG. 1, according to one embodiment of the present invention;

### DETAILED DESCRIPTION OF ILLUSTRATED EMBODIMENTS

Embodiments of the present invention are directed to systems, methods and articles of manufacture for preparing a tax return for a taxpayer which prioritize form fields to improve the efficiency with which a user can fill-in all required form fields to complete a tax return, and provide a user interface which conveniently and efficiently displays each form field and indicates the status of each form field as a required form field, a completed form field or an optional form field, and also provide for easy and efficient navigation to each form field, such as between form fields on the same tax form or between form fields on different tax forms. The tax preparation system receives tax form information from a web service which includes form fields for a tax form of a tax return. The form fields include required form fields which have not been completed by the user and are needed to complete the tax return, completed form fields which have already been completed by the user, and in some cases, optional form fields which the user may fill-in but are not needed to complete the tax return. The system prioritizes the required form fields using a set of prioritization rules such that their priority ranking can be utilized to order the form fields in a manner which reduces the amount of user interaction, computing resources and network communication resources required to complete the tax return. For instance, the prioritization may determine that filling in one or more required form fields may eliminate the need to fill-in other required form fields. The system also maps each of the form fields with a respective status identifier indicating whether the form field is a required form field, a completed form field or an optional form field. The system then generates a user interface for display to the user on a display of the system using the mapping and the priority ranking THe user interface includes each of the form fields in an order based upon the priority ranking and a selectable status maker associated with each form field which indicates whether the form field is a required form field, a completed form field or an optional form field (e.g., the status markers for each status may be different colors, different shapes, different words, or other suitable distinguishable graphics). The status markers are selectable such that selecting a status marker associated with a particular form field places a cursor in the particular form field such that the user can quickly and easily navigate to the particular form field and then navigate to the next desired form field by selecting another status marker associated with the next desired form field. The status markers may be conveniently arranged in a diagnostic bar so that a user can quickly scan and/or scroll through the status markers to rapidly and efficiently complete all of the form fields required to complete the tax return.

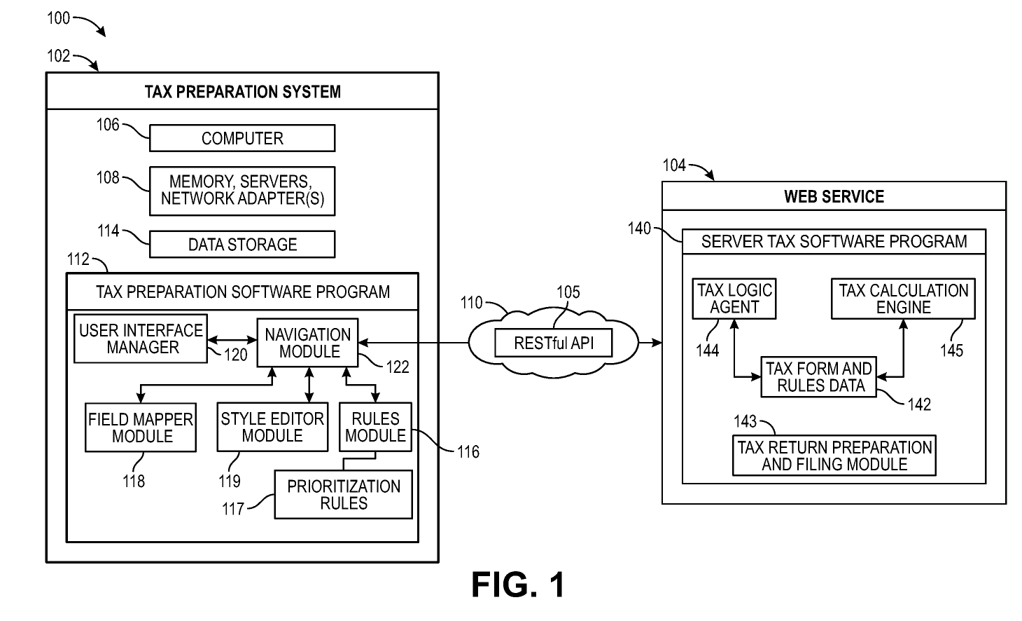

Referring to FIG. 1, in one embodiment, a block diagram of a computerized tax system 100 for preparing an electronic tax return is shown. The electronic tax return system 100 comprises a tax preparation system 102 which is in communication with a web service 104 via one or more communication networks 110. The communication network 110 may include the internet, LAN, WAN, cellular network, wireless network, proprietary network, and/or other suitable network. A RESTful API 105, or other suitable API, may be utilized to enable the communication between the tax preparation system 102 and the web service 104. The web service 104 may be operated by a tax preparation services provider, a third party service provider, a financial institution or by a third party host. One example of a third party host that provides web services for tax preparation is Intuit, Inc.

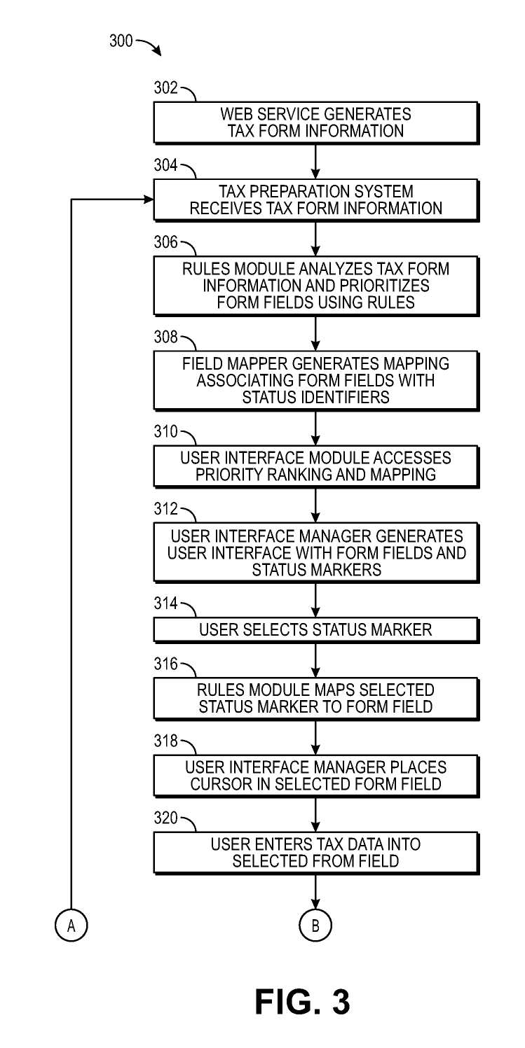

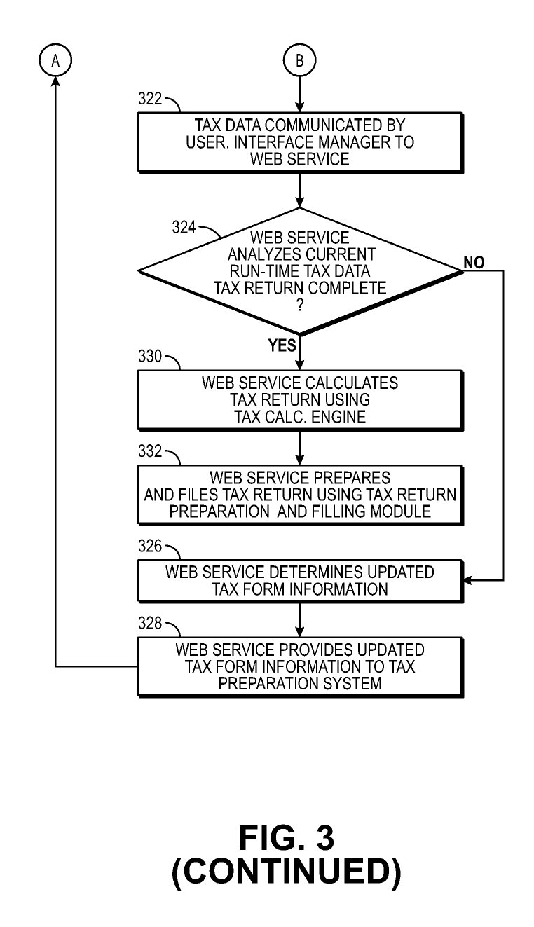

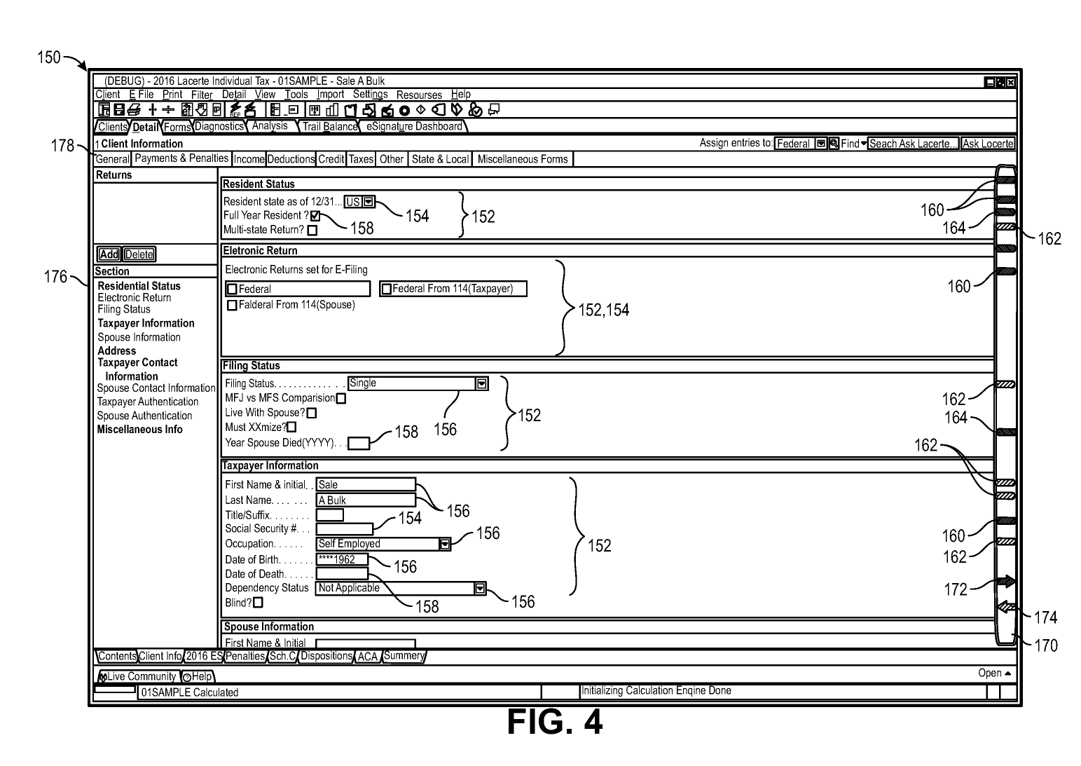

The tax preparation system 102 comprises: one or more computer(s) 106; peripheral hardware 108 such as memory, servers, communication network adapters, etc.; a tax preparation software program 112 executable by the computer(s) 106; and a data storage device 114 for storing data, such as tax data. The computer 106 may be any suitable computing device, including a mainframe computer, a personal computer (including a desktop computer, laptop computer or tablet computer), a server computer, a smartphone, or other suitable computing device. For example, the tax preparation system 102 may be a desktop/notebook computer based system (see e.g., FIGS. 3 and 4) in which the tax preparation software program 112 is installed on the desktop/notebook computer. In another embodiment, the tax preparation system 102 may be an internet browser based system (see e.g., FIGS. 3 and 4) in which the tax preparation software program 112 is a plug-in for an internet browser installed on the computer 104. In still another embodiment, the tax preparation system 102 may be a mobile computing device (e.g., a smartphone, tablet computer, etc.) based system (see e.g., FIGS. 3 and 4) in which the tax preparation software program is an application (“app”) installed on the mobile computing device.

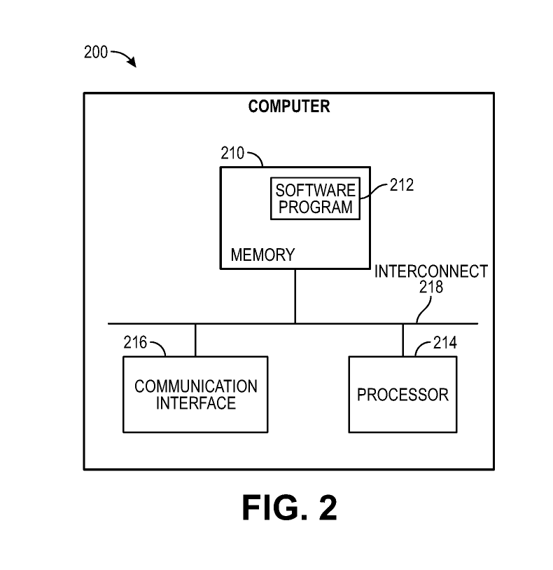

FIG. 2 generally shows a block diagram of the components of an example of a computer (computing device) 200 that may be used as the computer 106 tax preparation system 102 of FIG. 1. The computer 200 includes memory 210, an application software program 212, a processor or controller 214 to execute the application software 212, a network or communications interface 216, e.g., for communications with a network or interconnect 218 between the components. The memory 210 may be or include one or more of cache, RAM, ROM, SRAM, DRAM, RDRAM, EEPROM, SDRAM and other types of volatile or non-volatile memory capable of storing data. The processor unit 214 may be or include multiple processors, a single threaded processor, a multi-threaded processor, a multi-core processor, or other type of processor capable of processing data. Depending on the particular system component (e.g., whether the component is a computer or a hand held mobile communications device), the interconnect 218 may include a system bus, LDT, PCI, ISA, or other types of buses, and the communications or network interface may, for example, be an Ethernet interface, a Frame Relay interface, or other interface. The network interface 216 may be configured to enable a system component to communicate with other system components across a network which may be a wireless network or various other communication networks. It should be noted that one or more components of computer 200 may be located remotely and accessed via a network. Accordingly, the system configuration provided in FIG. 2 is provided to generally illustrate how embodiments may be configured and implemented.

The tax preparation system 102 communicates with the web service 104 via the communication network 110 and the RESTful API 105 to prepare a tax return for a taxpayer. The web service 104 has a server tax software program 140 in which all of the required tax rules and tax forms 142 for preparing the tax return are established in data structures which the web service 104 can utilize to analyze taxpayer tax data for a particular tax return to process, calculate and prepare a tax return. The web service 104 also has a tax logic agent 144 configured to analyze current run-time tax data for a tax return in view of the tax form and rules data 142 to evaluate form fields of the tax forms and determine which are required form fields needing tax data input to complete a tax form, which are completed fields for which tax data has previously been input, and which are optional fields which a user may fill-in with tax data but are not required in order to complete a tax form or a tax return. Based on this analysis, the tax logic agent 144 generates tax form information to provide to the tax return preparation system 102, in order to obtain tax data from the tax return preparation system 102 to complete the required fields. The tax logic agent 144 may comprise a machine learning (ML) component, such as an ML Experiment, which is capable of implementing tax rules and tax forms into the data structures for use and analysis by the tax logic agent without being manually programmed into the system. The tax form information received by the tax preparation system includes tax form data, including the tax form formatting and the form fields for completing the tax form or a full tax return. The tax form information includes “required fields” which are form fields which have not been filled-in and are required to complete the tax return, completed fields which are form fields which have been previously filled-in with tax data, and/or optional fields which are form fields which a user may fill-in with tax data but are not required in order to complete a tax form or a tax return. The tax form information may also include tax form formatting data, such as the look and order of the form fields in the tax form. The web service 104 also has a tax calculation engine 145 configured to utilize the run-time tax data to calculate a tax return. The web service 104 also has a tax return preparation and filing module 143 for preparing the final tax return (whether it be a paper return or an electronic return), and electronically filing the tax return with the appropriate tax agency. The web service 104 may utilize a tax filing intermediary service for electronically filing the tax return with the tax agency, or it may file it directly with the tax agency.

The tax preparation software program 102 includes a plurality of functional modules which perform different functions in a process for preparing a tax return for a taxpayer, including a rules module 116, a field mapper module 118, a user interface manager 120, a navigation module 122, and a style editor module 119. The tax preparation software program 102 is configured to receive the tax form information from the web service 104 and process the tax form information to generate user interfaces for allowing a user to input tax data need to complete the tax forms. Accordingly, the navigation module 122 is configured to enable communication between each of the modules of the tax preparation software program 102, including the rules module 116, the field mapper module 118, and the user interface manager 120. The navigation module also enables communication between the tax preparation system 102 and the web service 104, including between the tax preparation software program 102 and the server tax software program 140.

The rules module 116 is configured to analyze the tax form information received from the web service 104. Based on the analysis, the rules module 116 prioritizes the form fields using a set of predetermined prioritization rules 117 and generates a priority ranking of the form fields, which may include the required fields, the completed fields, and/or the optional fields. In general, the priority ranking ranks the form fields in a manner in which the user interface manager can arrange the form fields to reduce the amount of user interaction required to complete all of the required fields for completing a tax form and/or a full tax return compared to simply arranging the form fields as they are arranged on the actual tax forms. For example, filling in one or more required fields first may eliminate the need to fill-in other previously required fields. As one specific example, if a user selects “single” in a required field for the taxpayer's filing status, then the form fields for spousal data is not needed. Similarly, if a user selects “no dependents,” then the form fields for dependent data is not needed. The priority ranking may be a ranking index assigned to each of the form fields, or it may simply be an order of the form fields from highest priority to lowest priority.

The set of predetermined prioritization rules 117 are rules the rules module 116 utilizes to determine the priority ranking of the form fields. As several examples, a first prioritization rule may increase a measure of priority of a form field which requires the same tax data in other form fields, such as across different tax forms, or even within the same tax form. A second prioritization rule may increase a measure of priority of a form field which when filled-in will eliminate the need to fill-in other form fields. A third prioritization rule may decrease a measure of priority of a form field which is dependent upon other form fields. These examples are not limiting and other rules are also possible.

The field mapper module 118 is configured to generate a mapping which associates each of the form fields received from the web service to respective status identifiers. The field mapper module uses the tax form information received from the web service, including the form fields, and associates each of the form fields to a status identifier. The status identifiers indicate whether a form field is a required field, a completed field or an optional field. The field mapper 118 may also determines an associated form field within a user interface when a user selects a status marker displayed on the user interface, as described in more detail herein.

The user interface manager 120 is configured to receive the priority ranking generated by the rules module 116 and the mapping generated by the field mapper module via the navigation module 122. The user interface manager 120 then uses the priority ranking and the mapping to generate a user interface for display to a user in order to allow a user to input tax data. The user interface manager 120 uses the priority ranking to order the form fields in a manner which reduces the amount of user interaction required to complete the tax forms.

An example of a user interface 150 generated by the user interface manager 120 is shown in FIG. 4. The user interface 150 includes each of the form fields 152, including required fields 154, completed fields 156 and optional fields 158. The user interface also includes a respective visible and selectable status marker 160, 162, 164 associated with each of the form fields 152. The status markers 160, 162, 164 are colored lines or bars arranged in a vertical diagnostic bar 170 in a column such that each status marker is horizontally even (i.e., in a same row) as its associated form field 152. In this example user interface 150, the status markers 160, 162, 164 are color coded to indicate the status. Each of the status markers 160 are red in color (status markers 160 are labeled “red”) and indicate the associated form field is a required field 154 Each of the status markers 162 (status markers 162 are labeled “green”) are green in color and indicate the associated form field is a completed field 156. Each of the status markers 164 are yellow in color (status markers 164 are labeled “red”) and indicate that the associated form field 158 is an optional field 158. It is to be understood that the status markers 160, 162, 164 may be other colors to indicate their respective status, or different shapes and/or colors for each respective status, or a different word for each respective status, or other symbols differing in appearance such that a user can quickly and easily determine the status or an associated form field 152.

The status markers 160, 162, 164 are selectable, such as a selectable button or icon which as user can select using a cursor or other user input device of the computer 106 (e.g., a touchscreen, mouse, touchpad, keyboard, etc.). The user interface 150 is configured to detect the selection of a status marker 160, 162, 164 and automatically place a cursor (e.g., a pointer, cursor, arrow, caret, text cursor, highlight, etc.) in the form field associated with the selected status marker to show the current position for a user to enter tax data into the form field.

The user interface 150 may also include tax form selection commands 172, 174 in order to advance to a next tax form or to go back to a previous tax form. The tax form selection commands 172, 174 may be color coded to indicate whether the respective next tax form and previous tax form have required fields 154 or only completed fields 156. The example user interface 150 of FIG. 6 has a “next form” command 172 in the form of an arrow pointing to the right to indicate that selecting the arrow will advance the user interface to the next form. The “next form” command 172 is red in color (labeled “red”) indicating that the next form after the currently displayed form has one or more required fields 154 to be filled-in with tax data by the user. The “previous form” command 174 is in the form of an arrow pointing to the left to indicate that selecting the arrow will go back to the form previous to the currently displayed form. The “previous form” command 174 is green in color (labeled “green”) indicating that the tax form previous to the currently displayed form has only completed fields 156 and does not have any required fields 154.

The user interface 150 may also have other navigation tools and commands, such as a selectable tax form topic list 176 which has a list of tax topics which the user can select to navigate the user interface to the selected tax form topic. The user interface 150 may also have tax topic tab 178 for navigating to various tax topics for completing a tax return, such as “General”, “Payments & Penalties,” “Income,” “Deductions,” “Credits,” “Taxes,” “Other,” State & Local,” and “Miscellaneous Forms.”

The style editor module 119 is configured to allow the user to customize the look and feel of the user interface 150 generated by the user interface manager 120. The style editor 119 allows the user to customize the color, location, size, configuration, shape, and/or other characteristics of the diagnostic bar 170, the status markers 160, 162, 164. The style editor 119 may also allow the user to re-arrange the various commands, and features on the user interface, such as moving the diagnostic bar 170 to the left or right, or moving the diagnostic bar 170 to be on the left side of the form fields 152 displayed on the user interface 150.

Turning now to FIG. 3, a flow chart showing an algorithm of a method 300 for preparing a tax return for taxpayer using the tax system 100 according to one embodiment of the present invention is illustrated. At step 302, the web service 104 generates tax form information to provide to the tax preparation system 102, as described above. If the preparation of the tax return is just beginning, then the tax form information will start for a new tax return. If the preparation of the tax return is continuing from a previous session, then the web service 104 will utilize the current run-time tax data for the tax return.

At step 304, the tax preparation system 102 receives the tax form information via the navigation module 122 (and may also be via the RESTful API 105), including tax form data and data regarding form fields 152 comprising required fields 154, completed fields 156 and/or optional fields 158. At step 306, the rules module 116 analyzes the tax form information and prioritizes the form fields 152 using the predetermined set of prioritization rules 117.

At step 308, the field mapper generates a mapping which associates each of the form fields 152 to a respective status identifier, such as identifying each field as either a required field, a completed field or an optional field. At step 310, the user interface manager 120 access the priority ranking and mapping are accessed by via the navigation module 122. At step 312, the user interface manager 120 generates a user interface 150 for display to a user using the mapping and the priority ranking. The user interface 150 includes each of the form fields in an order based at least in part upon the priority ranking. The user interface also includes the status markers 160, 162 and 164 indicating whether each of the form fields is a required field, a completed field, or an optional field. The user interface 150 may also include the other features as described herein.

At step 314, a user selects one of the status markers, such as a red status marker 160, which indicates the associated form field is a required field 154. At step 316, the rules module 116 may map the selected status marker 160 to its associated required field 154, or the system 102 may utilize the previous mapping to identify the associated required field. At step 318, the user interface manager 120 places a cursor in the selected required field 154. At step 320, the user enters tax data into the selected required field 154. At step 322, the tax data input into the selected required field 154 is communicated by the user interface manager 120 to the navigation module 122 which in turn communicates the tax data and identification of the selected required field 154 to the web service 104 (again, which may be via the RESTful API 105).

At step 324, the web service 104 analyzes the current-run time tax data, including the tax data just entered into the selected required field 154, and determines whether the tax return is complete. If tax return is not complete, then at step 326, the web service 104 determines updated tax form information using the tax logic agent 144, as described above. The updated tax information includes updated tax form data and updated form fields, including updated required fields, updated completed fields, and/or updated optional fields.

At step 328, the web service 104 provides the updated tax form information to the tax preparation system 102, as described herein. The process of steps 302-326 may then repeat until all of the required tax data for completing all of the needed tax forms for a complete tax return has been acquired.

If at step 324, the tax return is complete, and all of the required tax data has been obtained, then the process proceeds to step 330 in which the web service 104 utilizes the tax calculation engine 145 to calculate the tax return using the run-time tax data. Then, at step 332, the web service 104 uses the tax return preparation and filing module 143 to prepare the tax return and file it with the appropriate tax agency.

The algorithms, processes, and method embodiments described herein, may also be embodied in, or readable from, a computer-readable medium (computer program carrier), e.g., one or more of the fixed and/or removable data storage data devices and/or data communications devices connected to a computer, including a non-transitory computer medium having instructions that when executed by a computer perform the described methods. The computer program carrier is readable by a computer and embodies instructions executable by the computer to perform the method steps of programming a computer to perform the methods implemented by the system 100 and/or its components, as described herein. Carriers may be, for example, magnetic storage medium, optical storage medium and magneto-optical storage medium. Examples of carriers include, but are not limited to, a floppy diskette, a memory stick or a flash drive, a hard drive, CD-R, CD-RW, CD-ROM, DVD-R, and DVD-RW.

Although particular embodiments have been shown and described, it is to be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, while multiple embodiments and variations of the many aspects of the invention have been disclosed and described herein, such disclosure is provided for purposes of illustration only. Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process as well as performed sequentially.

Accordingly, embodiments are intended to exemplify alternatives, modifications, and equivalents that may fall within the scope of the claims.

What is claimed is:

1. A system for preparing an electronic tax return for a taxpayer, comprising:
a tax preparation system including a computer having a computer processor, memory, a storage device for reading and writing tax data to the storage device, and a tax preparation software application; and
the tax preparation software application including a rules module configured to analyze and prioritize a plurality of form fields based on a set of predetermined prioritization rules, a field mapper module configured to map form fields to respective status identifiers, a user interface manager configured to generate a user interface for display to a user, and a navigation module configured to transfer data between each of the field mapper, rules module, and a user interface manager;
the tax preparation software application configured to program the computer to perform a process for preparing an electronic tax return for a taxpayer, comprising:
receiving tax form information from a web service, including form fields for completing tax forms for a tax return being prepared for a taxpayer, the form fields including required fields which have not been filled-in and are required to complete the tax return, completed fields which have been previously filled-in with tax data,
the rules module analyzing the tax form information and prioritizing the required fields to be filled out by the user according to the pre-determined set of prioritization rules to generate a priority ranking of the form fields;
the field mapper module generating a mapping associating each of the form fields to respective status identifiers, the status identifiers indicating whether a form field is a required field or a competed field;
the user interface manager receiving the mapping and the priority ranking and generating a user interface for display to a user using the mapping and the priority ranking, the user interface including each of the form fields in an order based upon the priority ranking and a respective visible status marker associated with each of the form fields, the status marker indicating whether the respective form field is a required field or a completed field, the status markers arranged in a diagnostic bar.

2. The system of claim 1, wherein each of the status markers for the required fields has a same first appearance, and each of the status markers for the completed fields has a same second appearance, the second appearance being different from the first appearance.

3. The system of claim 1, wherein each of the status markers for the required fields is a first color and each of the status markers for the completed fields is a second color different from the first color.

4. The system of claim 1, wherein each of the status markers is selectable such that selection of a particular status marker places a cursor in a form field associated with the selected status marker.

5. The system of claim 1, wherein the pre-determined set of prioritization rules comprises:
increasing a measure of priority of required fields which require the same tax data across different tax forms;
increasing a measure of priority of required fields which when completed will eliminate the need to fill-in other required fields; and
decreasing a measure of priority to required fields which are dependent upon other required fields.

6. The system of claim 1, wherein the process for preparing an electronic tax return for a taxpayer further comprises;
the user interface manager receiving tax data input into one of the form fields;
the navigation receiving the tax data input from the user interface manager and transmitting the tax data input to the web service;
receiving updated tax form information from the web service, including updated form fields for completing the tax forms for the tax return, the updated form fields including updated required fields, and updated completed fields;
the rules module analyzing the updated tax form information and prioritizing the updated required fields to be filled out by the user according to the pre-determined set of prioritization rules to generate an updated priority ranking of the updated form fields;
the field mapper module generating an updated mapping of the form fields to respective status identifiers;
the user interface manager receiving the updated mapping and the updated priority ranking and generating an updated user interface for display to a user using the updated mapping and the updated priority ranking, the updated user interface including each of the updated form fields in an order based upon the updated priority ranking and a respective visible status marker associated with each of the updated form fields.

7. The system of claim 1, wherein the tax preparation software application further includes a style editor module, the style editor module configured to allow a user to customize the look and feel of the user interface generated by the user interface module.

8. The system of claim 7, wherein the style editor module allows the user to customize the diagnostic bar and the status markers.

9. The system of claim 1, further comprising the web service, the web service including a tax logic agent configured to analyze current tax form data and current run-time tax data to determine required data fields required to complete the tax return, and provide tax information regarding form fields, required fields and completed fields to the tax preparation system.

10. The system of claim 1, wherein the navigation module communicates with the web service via a restful API.

11. A computerized method for preparing an electronic tax return for a taxpayer, comprising:
a tax preparation system executing a tax preparation software application, the tax preparation system including a computer having a computer processor, memory, a storage device for reading and writing tax data to the storage device, the tax preparation software application configured to prepare an electronic tax return and including a rules module, a field mapper module, a user interface manager, and a navigation module;
the tax preparation system receiving tax form information from a web service, including form fields for completing tax forms for a tax return being prepared for a taxpayer, the form fields including required fields which have not been filled-in and are required to complete the tax return, completed fields which have been previously filled-in with tax data,
the rules module analyzing the tax form information and prioritizing the required fields to be filled out by the user according to the pre-determined set of prioritization rules to generate a priority ranking of the form fields;
the field mapper module generating a mapping associating each of the form fields to respective status identifiers, the status identifiers indicating whether a form field is a required field or a competed field;
the user interface manager receiving the mapping and the priority ranking and generating a user interface for display to a user using the mapping and the priority ranking, the user interface including each of the form fields in an order based upon the priority ranking and a respective visible status marker associated with each of the form fields, the status marker indicating whether the respective form field is a required field or a completed field, the status markers arranged in a diagnostic bar.

12. The method of claim 11, wherein each of the status markers for the required fields has a same first appearance, and each of the status markers for the completed fields has a same second appearance, the second appearance being different from the first appearance.

13. The method of claim 11, wherein each of the status markers for the required fields is a first color and each of the status markers for the completed fields is a second color different from the first color.

14. The method of claim 11, wherein each of the status markers is selectable such that selection of a particular status marker places a cursor in a form field associated with the selected status marker.

15. The method of claim 11, wherein the pre-determined set of prioritization rules comprises:
increasing a measure of priority of required fields which require the same tax data across different tax forms;
increasing a measure of priority of required fields which when completed will eliminate the need to fill-in other required fields; and
decreasing a measure of priority to required fields which are dependent upon other required fields.

16. The method of claim 11, wherein the method further comprises;
the user interface manager receiving tax data input into one of the form fields;
the navigation receiving the tax data input from the user interface manager and transmitting the tax data input to the web service;
receiving updated tax form information from the web service, including updated form fields for completing the tax forms for the tax return, the updated form fields including updated required fields, and updated completed fields;
the rules module analyzing the updated tax form information and prioritizing the updated required fields to be filled out by the user according to the pre-determined set of prioritization rules to generate an updated priority ranking of the updated form fields;
the field mapper module generating an updated mapping of the form fields to respective status identifiers;
the user interface manager receiving the updated mapping and the updated priority ranking and generating an updated user interface for display to a user using the updated mapping and the updated priority ranking, the updated user interface including each of the updated form fields in an order based upon the updated priority ranking and a respective visible status marker associated with each of the updated form fields.

17. The method of claim 11, wherein the tax preparation software application further includes a style editor module, and the method further comprises:
the style editor receiving instructions from the user to customize the look and feel of the user interface generated by the user interface module.

18. The method of claim 17, wherein the style editor module customizes the diagnostic bar and the status markers.

19. The method of claim 11, wherein the tax preparation system further comprises the web service, and the method further comprises:
the web service executing a tax logic agent to analyze current tax form data and current run-time tax data to determine required data fields required to complete the tax return, and
the web service providing the tax information regarding form fields, required fields and completed fields to the navigation module.

20. The method of claim 11, wherein the web service provides the tax information to the navigation module via a restful API.

21. An article of manufacture comprising a non-transitory computer program carrier readable by a computer and embodying instructions executable by the computer to perform a method for preparing an electronic tax return for a taxpayer, the method comprising:
executing a tax preparation software application, the tax preparation system including a computer having a computer processor, memory, a storage device for reading and writing tax data to the storage device, the tax preparation software application configured to prepare an electronic tax return and including a rules module, a field mapper module, a user interface manager, and a navigation module;
the tax preparation system receiving tax form information from a web service, including form fields for completing tax forms for a tax return being prepared for a taxpayer, the form fields including required fields which have not been filled-in and are required to complete the tax return, completed fields which have been previously filled-in with tax data,
the rules module analyzing the tax form information and prioritizing the required fields to be filled out by the user according to the pre-determined set of prioritization rules to generate a priority ranking of the form fields;
the field mapper module generating a mapping associating each of the form fields to respective status identifiers, the status identifiers indicating whether a form field is a required field or a competed field; and
the user interface manager receiving the mapping and the priority ranking and generating a user interface for display to a user using the mapping and the priority ranking, the user interface including each of the form fields in an order based upon the priority ranking and a respective visible status marker associated with each of the form fields, the status marker indicating whether the respective form field is a required field or a completed field, the status markers arranged in a diagnostic bar.
